(19) United States
(12) Patent Application Publication
(10) Pub. No.: US 2013/0095222 A1
(43) Pub. Date: Apr. 18, 2013

(54) BREAD AND METHOD FOR MAKING

(71) Applicant: Kelly Monassebian, Great Neck, NY (US)

(72) Inventor: Kelly Monassebian, Great Neck, NY (US)

(21) Appl. No.: 13/654,601

(22) Filed: Oct. 18, 2012

Related U.S. Application Data
(60) Provisional application No. 61/548,293, filed on Oct. 18, 2011.

(51) Int. Cl. A21D 13/02; A21D 8/06

(52) U.S. Cl. 426/558; 426/496

(57) ABSTRACT

A bread product including oat bran, a thickened product and egg whites is disclosed. The bread product is a nutritional food item having about 10 grams of protein per serving. The bread product is dense taking form as a pita and is not cakey like a pancake or muffin.

### PRIORITY AND RELATED APPLICATION

This application claims priority to U.S. Provisional Patent Application Ser. No. 61/548,293, filed Oct. 18, 2011, entitled “BREAD RECIPE,” which is hereby incorporated by reference in its entirety.

### FIELD OF THE INVENTION

The present invention relates to bread recipes and bread products resulting from the bread recipe.

### BACKGROUND OF THE INVENTION

Observing a diet full of healthy and nutritious food items is key to living a long and healthy life. However individuals who have diet restrictions must monitor their food intake to prevent bad food reactions. For instance individuals who must have a gluten free diet should stay away from many carbohydrates as they are rich in gluten. Unfortunately the staple of the American diet is bread. It can be eaten alone or as part of a sandwich breads. Producing a bread that is nutritious and has versatile usage is important to have. It is also important to produce food products that pack a lot of power without containing gluten. What is desired is a gluten-free bread that is a nutritional essential to the everyday diet.

### BRIEF SUMMARY OF THE INVENTION

A bread product is disclosed having oat bran, egg whites, and thickened product. The thickened product may include yogurt, cream cheese or tofu. The method to make the bread is by combining all items at once mixing it to be a thick and creamy batter then pouring the batter into a preheated pan. The pan is preheated to a high temperature on the stove then when the poured batter is flipped the heat is decreased to a medium-low temperature to cook for about 2-3 minutes. The cooked batter is flipped to the uncooked side to cook for about 3 minute at a low temperature and then flipped again to cook for 1 minute at a lowest temperature. The high, medium-low, low and lowest temperature is 500, 340, 270 and 200 degrees Fahrenheit respectively.

### DETAILED DESCRIPTION OF THE INVENTION

The present invention describes a bread product made of oat bran, egg whites and a thickened product. In one embodiment the bread product is made using 2 tablespoons of the thickened product, ¼ cup egg whites and 2 tablespoons oat bran. The bread product is nutritious having, in one serving of the bread, about 98.75 calories with 11.25 calories coming from fat. 1.3125 g of fat and 0.1875 g of saturated fat, 102.875 mg sodium, 90 mg potassium, 10.5625 g of carbohydrates, 0.5625 g of sugar, 2.25 g fiber and 10.0625 g protein. In another embodiment the bread product has about 17.6% oat bran, about 65.7% egg whites and about 16.7% thickened product.

The bread is made by mixing together the oat bran, egg whites and thickened product all at once. The thickened product can include yogurt such as but not limited to greek yogurt, tofu or cream cheese. To make one serving the mixture will have about 1 ½ to 3 tablespoons (15 g dry weight) of oat bran, about ¼ to ½ cup or 2-4 egg whites and about 14.1875 g of thickened product.

In one embodiment, the method to make the bread is by making it on a stove top burner cooked or generally fried on a cooking device such as but not limited to a pan. The pan is preheated on the stove top burner to high, a first temperature, then the bread batter poured therein. In some embodiments the pan may be coated with a non-stick spray or other non-stick cooking oil if necessary. The batter is made by mixing all together in a bowl such as a glass bowl the oat bran, egg whites and thickened product to be a thick and creamy batter. The quantity of each the oat bran, egg whites and thickened product are notable as is the mixing of each ingredient all at once. The egg whites are not foamed as such a process would defeat the dense character of the bread.

After mixing the three ingredients together to form the batter, it is poured slowly into the pre-heated pan and the stove top temperature is turned to medium-low, a second temperature.

The slow pour of the batter into the hot pan is notable as the technique together with the thick, creamy consistency of the batter keeps the batter in the center of the pan and prevents the batter from seeping to the sides of the pan. The batter is cooked at medium-low for 2-3 minutes or until air bubbles show on top. The bread is then flipped and the stove top temperature under the pan is turned down again to a low temperature, a third temperature. The bread is cooked at this third temperature for about three minutes. The bread is flipped one last time and the temperature is turned down again to a fourth temperature for cooking for about one minute. The bread is then taken off the pan and cooled for 10-15 minutes on a cooling rack.

The resulting bread product is dense and nutritious. The bread is both gluten-free and wheat free, provides a good source of protein and is low in sodium. The bread is dense like a pita. In one embodiment, the bread can be made in any shape such as a pita-shape where it can be cut in the middle and used like a pita sandwich bread.

While the present invention has been described in conjunction with specific embodiments, those of normal skill in the art will appreciate the modifications and variations can be made without departing from the scope and the spirit of the present invention. Such modifications and variations are envisioned to be within the scope of the appended claims.

1. A bread product comprising:
oat bran, egg whites, and a thickened product.

2. The bread product of claim 1 wherein said thickened product is a dairy.

3. The bread product of claim 1 wherein said thickened product is a yogurt.

4. The bread product of claim 1 wherein said thickened product is a tofu.

5. The bread product of claim 1 wherein said bread product is a pita bread.

6. The bread product of claim 1 wherein for making one serving of said bread product, said oat bran is about 1.5-3 tbsp, said egg whites is about ¼ to ½ cup and said thickened product is about 2 tbsp.

7. A bread product comprising:
oat bran, egg whites, and tofu.

8. The bread product of claim 8 wherein for making one serving of said bread product, said oat bran is about 1.5-3 tbsp, said egg whites is about ¼ to ½ cup and said thickened product is about 2 tbsp.

9. A method of making a bread comprising:
pre-heating a cooking device to a first temperature;
combining all at once egg whites, a thickened product and oat bran with a spoon producing a thick and creamy mixture;
slowly pouring the mixture in said cooking device, resulting in a first cooking side;
reducing said first temperature to a second temperature to cook said first cooking side of said mixture 2-3 minutes;
flipping the mixture to an opposite side from said first cooking side and reducing said second temperature to a third temperature, wherein said opposite side is cooked for about 3 minutes; and
flipping the mixture to said first cooking side and reducing said third temperature to a fourth temperature, wherein said first cooking side is cooked at said fourth temperature for about 1 minute,
wherein said first temperature is higher than said second temperature, said second temperature is higher than said third temperature, said third temperature is higher than said fourth temperature.

10. The method of claim 9, wherein said bread is a pita.

11. The method of claim 9, wherein said egg white is not foamed.

12. The method of claim 9, wherein said first temperature is about 500° F.

13. The method of claim 9, wherein said second temperature is about 340° F.

14. The method of claim 9, wherein said third temperature is about 270° F.

15. The method of claim 9, wherein said third temperature is about 200° F.
